(19) United States
(12) Patent Application Publication
(10) Pub. No.: US 2026/0076489 A1
(43) Pub. Date: Mar. 19, 2026

(54) Collapsible Carrycot And A Child Stroller Comprising The Same

(71) Applicant: Zhejiang Jinhua Snowbaby Baby Items Manufacturing Co., Ltd., Lanxi (CN)

(72) Inventors: Pin Qi Wang, Lanxi (CN); Sheng Jun Meng, Lanxi (CN); Chuan Xi Hu, Lanxi (CN)

(21) Appl. No.: 19/275,146

(22) Filed: Jul. 21, 2025

(30) Foreign Application Priority Data
Sep. 14, 2024 (CN) 202422261176.4
Mar. 16, 2025 (CN) 202520453403.5

(51) Int. Cl. A47D 13/02; B62B 7/06; B62B 9/12

(52) U.S. Cl. CPC A47D 13/027; B62B 7/06; B62B 9/12

(57) ABSTRACT

A collapsible carrycot such as to carry children or other persons or materials is provided. Aspects provide a compact form factor that is space efficient. The carrycot generally has an upper frame and a lower frame, each of which are composed of a plurality of frame bodies. The frame bodies are articulated and rotatably pivoting at certain pivoting parts and articulatable linkages formed of connecting rods and supporting rods to permit easy and safe use. The carrycot can further be part of a stroller apparatus into which the collapsible carrycot is secured.

### RELATED APPLICATIONS

This application claims the benefit and priority of Chinese Patent Application Serial No. 202422261176.4 filed Sep. 14, 2024, and Chinese Patent Application Serial No. 202520453403.5 filed Mar. 16, 2025, which are hereby incorporated by reference.

### TECHNICAL FIELD

The present application relates to a transportation device for children, and in particular to a collapsible carrycot and a child stroller comprising the same.

### BACKGROUND

Some child strollers have garnered extensive favor as they can be equipped with either a child seat or a carrycot to accommodate younger babies. Most of the carrycots fitted to the presently existing child strollers can only be folded by compressing the top and bottom frames from above and below, but cannot be folded in the longitudinal direction. In addition, the soft components such as the cloth cover have to be removed from the carrycot, so that subsequent manual operation may be subjected to the rods so as to remove support between the top frame and the bottom frame. This involves extremely cumbersome labor. Although a few carrycot products can be folded in the longitudinal direction, such folding is performed in a two-section folding manner, and the carrycot in a V-shape configuration after folding. As the rod bodies and the folding joint of the carrycot occupy certain space, the end of the rod bodies distal to the folding joint of the carrycot has a larger opening angle after folding. As a result, a certain space will still be occupied. On the other hand, forced compression may cause damage to the cloth cover soft component at the joint.

### SUMMARY

The present application thus provides a collapsible carrycot and a child stroller comprising the same which aims to overcome problems of the prior art including that when the carrycot is folded, the end of the carrycot rod bodies distal to the folding joint has a large opening angle, which still occupies certain space, and forced compression may cause damage to the cloth cover soft component at the joint.

Aspects of the prior art limitations and new improvements are addressed in the following disclosure.

An embodiment is directed to a collapsible carrycot comprising an upper frame having a first upper frame body and a second upper frame body, the first and second upper frame bodies being rotatably coupled to one another by an upper frame pivoting part, so that the first and second upper frame bodies are foldable with respect to one another about said upper frame pivoting part; a lower frame having a first lower frame body, a second lower frame body, and a third lower frame body, the first and third lower frame bodies being rotatably coupled to one another, and the second and third lower frame bodies being rotatably coupled to one another, so that the first and second lower frame bodies are foldable with respect to one another about said third lower frame body; a first collapsible assembly collapsibly coupling said first upper frame body and said first lower frame body; a second collapsible assembly collapsibly coupling said second upper frame body and said second lower frame body; wherein the carrycot is convertible between an extended position with said upper frame pivoting part in a first position thereof, and a collapsed position with said upper frame pivoting part in a second position thereof.

An embodiment is directed to a collapsible stroller and carrycot apparatus, comprising a stroller frame having a plurality of stroller frame coupling points configured to mechanically couple to a corresponding plurality of carrycot coupling points; a stroller handle proximal to an upper portion of said stroller frame; a plurality of stroller wheels proximal to a lower portion of said stroller frame; and a collapsible carrycot comprising an upper carrycot frame and a lower carrycot frame; wherein said upper carrycot frame includes a first upper frame body, a second upper frame body, said first and second upper frame bodies being rotatably foldable with respect to one another by way of a lockable upper frame pivoting part; wherein said lower carrycot frame includes a first lower frame body, a second lower frame body, and a third lower frame body, said first and third lower frame bodies being rotatably foldable with respect to one another by way of a first lower frame pivoting part, and said second and third lower frame bodies being rotatably foldable with respect to one another by way of a second lower frame pivoting part; wherein said collapsible carrycot is foldably convertible between an extended position and a collapsed position; wherein in the extended position of the carrycot: each of said first and second upper frame bodies is open about said upper frame pivoting part and secured in said extended position by a locking device, and wherein each of said first, second and third lower frame bodies is open about said respective first and second lower frame pivoting parts; and wherein in the collapsed position of the carrycot: each of said first and second upper frame bodies is closed about said upper frame pivoting part and secured in said collapsed position by said locking device, and wherein each of said first, second and third lower frame bodies is closed about said respective first and second lower frame pivoting parts.

An embodiment is directed to a collapsible carrycot comprising an upper frame, a lower frame and a collapsible assembly, wherein the upper frame comprises a first upper frame body, a second upper frame body and a first pivoting part, the first upper frame body and the second upper frame body are connected via the first pivoting part, and each of the first upper frame body and the second upper frame body is separately foldable toward each other around the connection points thereof to the first pivoting part as the rotation points; the lower frame comprises a first lower frame body, a second lower frame body and a third lower frame body, the first lower frame body is rotatably connected to one end of the third lower frame body, the second lower frame body is rotatably connected to the other end of the third lower frame body, and each of the first lower frame body and the second lower frame body is separately foldable toward each other around the connection points thereof to the third lower frame body as the rotation points; wherein the collapsible assembly includes a first collapsible assembly between the first upper frame body and the first lower frame body, and a second collapsible assembly between the second upper frame body and the second lower frame body, and when the first upper frame body and the second upper frame body are folded toward each other, the first lower frame body and the second lower frame body are driven to be folded toward each other by the first collapsible assembly and the second collapsible assembly.

In some embodiments, the first upper frame body and the second upper frame body are connected via the first pivoting part, and can be separately folded upward around the connection points thereof to the first pivoting part as the rotation points. The first lower frame body and the second lower frame body can also be separately foldable toward each other around the connection points thereof to the third lower frame body as the rotation points. In some embodiments, the first collapsible assembly is disposed between the first upper frame body and the first lower frame body, and the second collapsible assembly is disposed between the second upper frame body and the second lower frame body. When the first upper frame body is folded upward around a rotation point which is the connection point to the first pivoting part, the first lower frame body is driven, by the first collapsible assembly, to be folded upward around a rotation point which is at the connection point to the third lower frame body. In some embodiments, when the second upper frame body is folded upward, the second lower frame body will also be driven to be folded upward, so as to reduce the storage space occupied by the carrycot. When the carrycot is to be unfolded for use, the first and second upper frame bodies are pulled apart which will also drive the first and second lower frame bodies to be unfolded. Since the third lower frame body is disposed between the first lower frame body and the second lower frame body, the lower frame is in a three- section-configuration after being folded. As a result, the third lower frame body will provide storage space between the first lower frame body and the second lower frame body in the folded state. On one hand, when folded, the first lower frame body, the second lower frame body and the third lower frame body are arranged in a U-shape configuration, which occupies less space than the two-section and V-shaped frame. On the other hand, the canopy and the cloth cover soft components are less likely to be damaged by the compression and the flatness after folding can be improved.

In some embodiments, the collapsible carrycot further includes a locking assembly, which is used to lock the first pivoting part such that the first upper frame body and the second upper frame body, and the first lower frame body and the second lower frame body cannot be folded. In some embodiments, the collapsible carrycot comprises a folded state and an unfolded state. The locking assembly is in the locking state when the collapsible carrycot is in the unfolded state.

In some embodiments, when the carrycot is unfolded for use, the locking assembly locks the first pivoting part, so that the first and second upper frame bodies are unable to be folded. Since the first lower frame body and the second lower frame body are linked with the first upper frame body and the second upper frame body through the first collapsible assembly and the second collapsible assembly, respectively, when the first upper frame body and the second upper frame body cannot be folded, the first lower frame body and the second lower frame body cannot be folded, either. The above indicated structure is safer and more stable as compared with the structure which maintains the use state of the carrycot by using the fastening of the rotation point itself.

In some embodiments, the upper frame or the lower frame is provided with an unlocking assembly which can unlock the locking assembly.

The upper frame or the lower frame is provided with the unlocking assembly, and the operation thereof is more convenient and simpler as compared with the case where the locking assemblies on both sides need to be manually unlocked, or even the cloth cover soft component on the carrycot need to be removed before the operation to the first and second collapsible assemblies can be conducted.

In some embodiments, the first collapsible assembly includes a first connecting rod and a first supporting rod. One end of the first connecting rod is rotatably connected to the first upper frame body, and the other end of the first connecting rod is rotatably connected to the first lower frame body. One end of the first supporting rod is rotatably connected to the first upper frame body, and the other end of the first supporting rod is fixedly connected to the third lower frame body.

In some embodiments, the second collapsible assembly includes a second connecting rod. One end of the second connecting rod is rotatably connected to the second upper frame body, and the other end of the second connecting rod is rotatably connected to the second lower frame body.

In some embodiments, the position where first connecting rod is rotatably connected to the first upper frame body is in a direction where the position for rotatably connecting the first supporting rod to the first upper frame body is distal to the first pivoting part. In some embodiments, the position where first connecting rod is rotatably connected to the first lower frame body is in a direction where the position for fixedly connecting the first supporting rod to the third lower frame body is distal to the third lower frame body. With the above configurations, the first support rod, the first connecting rod, and the first upper frame body can be more compact when folded, and the structure is simple and reliable. In some embodiments, the position where first connecting rod is rotatably connected to the first upper frame body is in a direction where the position for rotatably connecting the first connecting rod to the first lower frame body is distal to the first pivoting part and the third lower frame body.

In some embodiments, the first supporting rod is configured such that it does not deform during the folding of the collapsible carrycot. In some embodiments, the first supporting rod is configured such that it does not slide relative to the first upper frame body. In some embodiments, the first connecting rod is configured such that it does not deform during folding or unfolding. In some embodiments, the first connecting rod is configured such that it does not slide relative to the first upper frame body and/or the first lower frame body. By “not deforming” or “not deform”, it means that a structure itself does not deform, especially including that the structure itself does not produce multiple sections of folding, or extension or retraction. In this way, the folding of the collapsible carrycot is achieved merely by the rotation between parts, which is simple and robust.

In some embodiments, the lower frame is consisted of the first lower frame body, the second lower frame body and the third lower frame body.

In some embodiments, the first supporting rod is fixedly connected to the third lower frame body. Under the folded state, the tilting degrees of the first upper frame body, the second upper frame body, the first lower frame body and the second lower frame body relative to the third lower frame body correspond to the tilting degree of the first supporting rod relative to the third lower frame body such that the carrycot can be tilted toward one side to fit the stroller frame, thereby facilitating the folding of the entire stroller. In addition, in the case where the third lower frame body is disposed on the frame of the child stroller, when the second upper frame body is folded upward, a force is applied to the first pivoting part to make it move downward. The downward movement of the first pivoting part will drive the other end of the first upper frame body to fold upward, as the position of the rotation point of the first supporting rod and the first upper frame body is fixed. As a result, only one hand is needed to fold the second upper frame body and cause the carrycot to be folded as a whole. The first collapsible assembly is further provided with a first connecting rod so that they connect to the upper frame and the lower frame at discrete positions to achieve an even distribution of the force, and thus providing a structure which is more stable and reliable and unlikely to deform. This embodiment has a simple structure, can be manufactured at a low cost and is not prone to malfunctions during use.

In some embodiments, the first collapsible assembly includes a first connecting rod and a first supporting rod. One end of the first supporting rod is rotatably connected to the first upper frame body, and the other end of the first supporting rod is rotatably connected to the third lower frame body. The first connecting rod comprises a first sub-rod, a second sub-rod, and a third sub-rod. The intermediate part of the third sub-rod is rotatably connected to the intermediate part of the first supporting rod. One end of the third sub-rod is rotatably connected to one end of the first sub-rod, and the other end of the third sub-rod is rotatably connected to one end of the second sub-rod. The other end of the first sub-rod is rotatably connected to a position of the first upper frame body proximal to the first pivoting part. The other end of the second sub-rod is rotatably connected to a position of the first lower frame body distal to the third lower frame body. The second collapsible assembly includes a second connecting rod. One end of the second connecting rod is rotatably connected to the second upper frame body, and the other end of the second connecting rod is rotatably connected to the second lower frame body.

In these embodiments, the upward folding of the second upper frame body will drive the second lower frame body to be folded upward. Meanwhile, the second upper frame body drives the first sub-rod to move downward through a downward force applied by the first pivoting part to the end of the first upper frame proximal to the first pivoting part. In addition, the intermediate part of the third sub-rod is rotatably connected to the intermediate part of the first supporting rod. The downward movement of the first sub-rod drives the third sub-rod to rotate around the connection point between the third sub-rod and the first supporting rod. Furthermore, as the third sub-rod is rotatably connected to the second sub-rod, the first sub-rod is rotatably connected to the first upper frame body, and the second sub-rod is rotatably connected to the first lower frame body, the rotation of the third sub-rod will pull the second sub-rod, and drive the first lower frame body folding upward. Furthermore, the first supporting rod is fixedly connected to the third lower frame body. As a result, in the folded state, the tilting degree of the first upper frame body, the second upper frame body, the first lower frame body and the second lower frame body correspond to the tilting degree of the first supporting rod such that the carrycot can be tilted toward one side to fit the stroller frame, thereby facilitating the folding of the entire stroller.

In some embodiments, the second collapsible assembly further includes a third connecting rod. One end of the third connecting rod is rotatably connected to the second upper frame body, and the other end of the third connecting rod is rotatably connected to the third lower frame body.

In these embodiments, the other end of the third connecting rod is rotatably connected to the third lower frame body. The positions where the second collapsible assembly connects to the upper frame and the lower frame are discrete so as to achieve an even distribution of the force, thus the structure is more stable and reliable, and is unlikely to deform.

In some embodiments, the first collapsible assembly includes a first connecting rod. One end of the first connecting rod is rotatably connected to the first upper frame body, and the other end of the first connecting rod is rotatably connected to the first lower frame body.

In these embodiments, the first collapsible assembly is linked to the folding motion of the first upper frame body and the first lower frame body through the first connecting rod disposed between the first upper frame body and the first lower frame body, thus achieving a simple structure and low manufacturing cost.

In some embodiments, the first collapsible assembly further includes a second connecting rod. One end of the second connecting rod is rotatably connected to the first upper frame body, and the other end of the second connecting rod is rotatably connected to the connection point between the first lower frame body and the third lower frame body.

In these embodiments, the other end of the second connecting rod is rotatably connected to the connection point between the first lower frame body and the third lower frame body. The first collapsible assembly connects to the upper frame and the lower frame at discrete positions so as to achieve an even distribution of force, thus achieving a stable structure and reliable, and is unlikely to deform.

In some embodiments, the second collapsible assembly and the first collapsible assembly are symmetrically arranged.

In these embodiments, the second collapsible assembly and the first collapsible assembly are symmetrically arranged. Therefore, the carrycot has a simple structure and low manufacturing cost.

In some embodiments, the first collapsible assembly includes a first connecting rod and a second connecting rod. One end of the second connecting rod is rotatably connected to the first upper frame body, and the other end of the second connecting rod is rotatably connected to the connection point between the first lower frame body and the third lower frame body. The first connecting rod comprises a first sub-rod, a second sub-rod, and a third sub-rod. The intermediate part of the third sub-rod is rotatably connected to the intermediate part of the second connecting rod. One end of the third sub-rod is rotatably connected to one end of the first sub-rod, and the other end of the third sub-rod is rotatably connected to one end of the second sub-rod. The other end of the first sub-rod is rotatably connected to a position of the first upper frame body proximal to the first pivoting part. The other end of the second sub-rod is rotatably connected to a position of the first lower frame body distal to the third lower frame body.

In these embodiments, both ends of the second connecting rod are rotatably connected to the first upper frame body, and the connection point between the first lower frame body and the third lower frame body. The upward folding of the first upper frame body drives rotation of the second connecting rod around a rotation point which is the connection point between the first lower frame body and the third lower frame body. In addition, the intermediate part of the third sub-rod is rotatably connected to the intermediate part of the second connecting rod. Rotation of the second connecting rod drives the third sub-rod to rotate around the connection point between the third sub-rod and the second connecting rod. Furthermore, as the third sub-rod is rotatably connected to the first sub-rod and the second sub-rod, the first sub-rod is rotatably connected to the first upper frame body, and the second sub-rod is rotatably connected to the first lower frame body, the rotation of the third sub-rod will pull the second sub-rod and thus render the first lower frame body fold upward. In the above indicated structure, the first collapsible assembly is in a cross X shape and its force-bearing connection positions with the first upper frame body and the first lower frame body are uniformly dispersed. Therefore, the structure is more stable and reliable.

In some embodiments, the second collapsible assembly and the first collapsible assembly are symmetrically arranged.

The second collapsible assembly and the first collapsible assembly are symmetrically arranged. The carrycot has a simple structure and low manufacturing cost.

A child stroller comprising any one of the above collapsible carrycot. In some embodiments, the first upper frame body and the second upper frame body of the carrycot of the child stroller are connected by the first pivoting part, and can be separately folded upward around the connection points thereof to the first pivoting part as the rotation points. Each of the first lower frame body and the second lower frame body can also be foldable toward each other around the connection points thereof to the third lower frame body as the rotation points. In addition, the first collapsible assembly is disposed between the first upper frame body and the first lower frame body, and the second collapsible assembly is disposed between the second upper frame body and the second lower frame body. When the first upper frame body is folded upward around a rotation point which is the connection point to the first pivoting part, the first collapsible assembly will drive the first lower frame body to be folded upward around a rotation point which is the connection point to the third lower frame body. Similarly, when the second upper frame body is folded upward, the second lower frame body will also be driven to fold upward so as to reduce the storage space occupied by the carrycot. When the carrycot needs to be unfolded for use, the first and second upper frame bodies are pulled, which will also cause unfolding of the first and second lower frame bodies. Since the third lower frame body is disposed between the first lower frame body and the second lower frame body, the lower frame is in a three-section-configuration when it has been folded. As a result, the third lower frame body will provide the storage space between the first lower frame body and the second lower frame body in the folded state. On one hand, after folding, the first lower frame body, the second lower frame body and the third lower frame body are arranged in a U-shape configuration, which occupies smaller space than the two-section V-shaped frame. On the other hand, the canopy and the cloth cover soft component are unlikely to be damaged by compression and their flatness after folding are improved.

### BRIEF DESCRIPTION OF THE DRAWINGS

FIG. 1 is a structural schematic view of a carrycot;

FIG. 2 is another structural schematic view of the carrycot;

FIG. 3 is a schematic view of the carrycot which is being folded;

FIG. 4 is a schematic view of the carrycot which has been folded;

FIG. 5 is a structural schematic view of a child stroller;

FIG. 6 is another structural schematic view of the child stroller;

FIG. 7 is a structural schematic view of a carrycot;

FIG. 8 is another structural schematic view of the carrycot;

FIG. 9 is a schematic view of the carrycot which is being folded;

FIG. 10 is a schematic view of the carrycot which has been folded;

FIG. 11 is a structural schematic view of a child stroller;

FIG. 12 is another structural schematic view of the child stroller;

FIG. 13 is a structural schematic view of a carrycot;

FIG. 14 is another structural schematic view of the carrycot;

FIG. 15 is a schematic view of the carrycot which is being folded;

FIG. 16 is a structural schematic view of a carrycot;

FIG. 17 is another structural schematic view of the carrycot;

FIG. 18 is a schematic view of the carrycot which is being folded; and

FIG. 19 is a structural schematic view of a locking device and pivoting part assembly.

### DETAILED DESCRIPTION

The present application will be described more clearly and completely with reference to the following preferred examples in conjunction with the accompanying drawings.

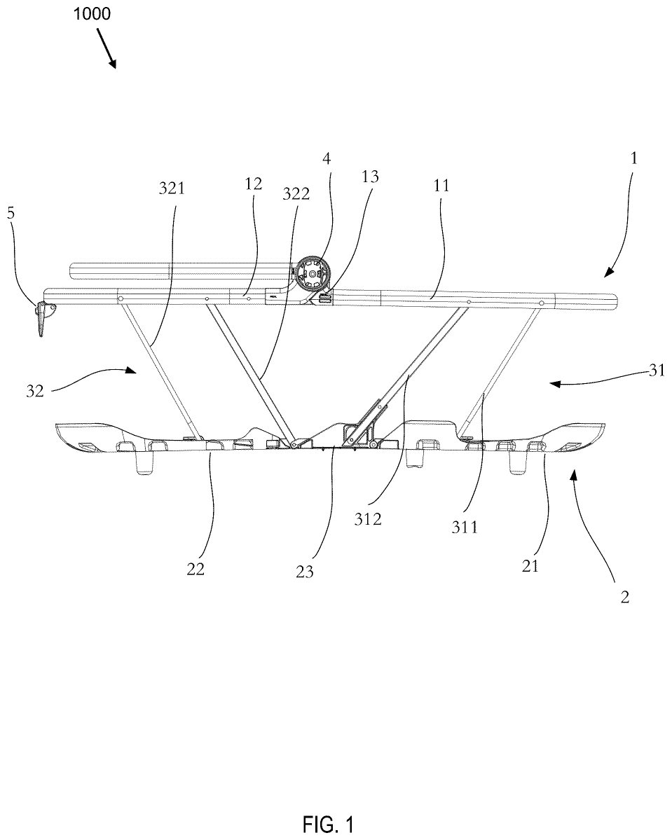

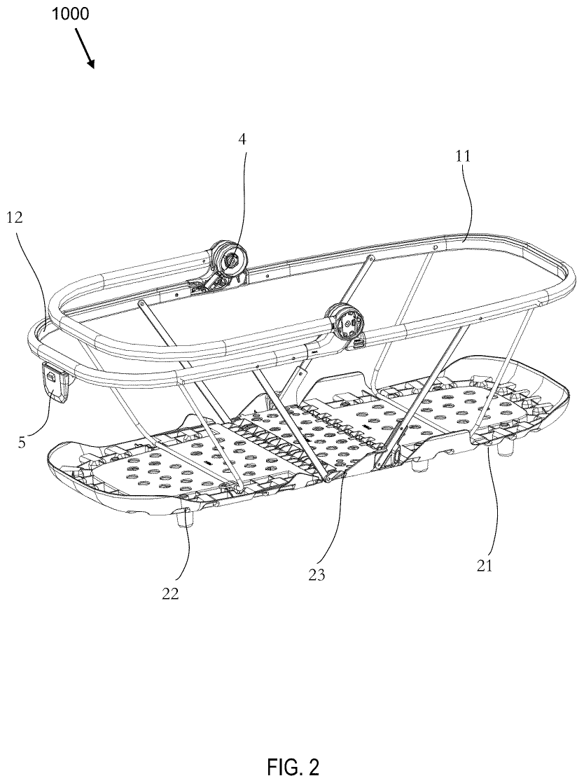

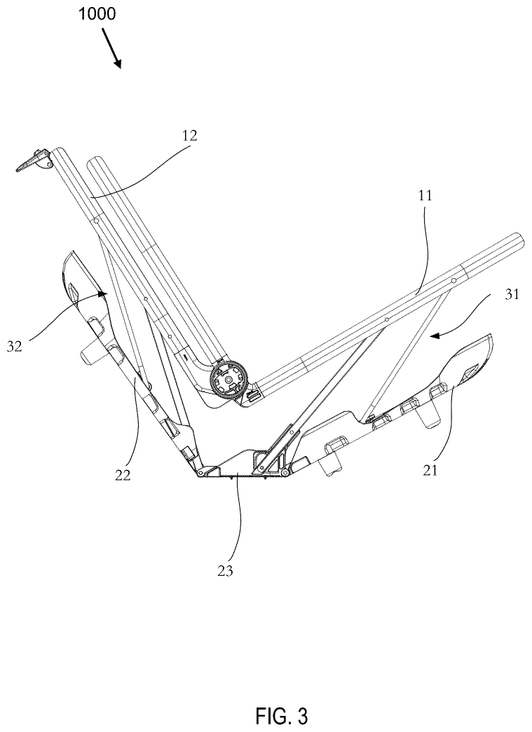

FIGS. 1 to 4 illustrate a collapsible carrycot 1000 comprising an upper frame 1, a lower frame 2 and a collapsible assembly. The upper frame 1 comprises a first upper frame body 11, a second upper frame body 12 and a first (upper frame) pivoting part 13. The first upper frame body 11 and the second upper frame body 12 are connected via the first pivoting part 13. The first upper frame body 11 and the second upper frame body 12 may be separately rotatably foldable toward each other around the connection points thereof to the first pivoting part 13 as the rotation points, which can comprise a pin, pivot or hinge. The lower frame 2 comprises a first lower frame body 21, a second lower frame body 22 and a third lower frame body 23. The first lower frame body 21 is rotatably connected to one end of the third lower frame body 23, and the second lower frame body 22 is rotatably connected to the other end of the third lower frame body 23. The first lower frame body 21 and the second lower frame body 22 may be separately rotatably foldable toward each other around the connection points thereof to the third lower frame body 23 as the rotation points. The collapsible assembly includes a first collapsible assembly 31 disposed between the first upper frame body 11 and the first lower frame body 21, and a second collapsible assembly 32 disposed between the second upper frame body 12 and the second lower frame body 22. When the first upper frame body 11 and the second upper frame body 12 are rotatably folded toward each other, the first collapsible assembly 31 and the second collapsible assembly 32 will drive the first lower frame body 21 and the second lower frame body 22 to be folded toward each other correspondingly. The first collapsible assembly 31 includes a first connecting rod 311 and a first supporting rod 312. One end of the first supporting rod 312 is rotatably connected to the intermediate part of the first upper frame body 11, e.g., using a pin or pivot or hinge joint, and the other end of the first supporting rod 312 is fixedly connected to the third lower frame body 23. One end of the first connecting rod 311 is rotatably connected to the first upper frame body 11, e.g., using a pin or pivot or hinge, and the other end of the first connecting rod 311 is rotatably connected to the first lower frame body 21. The second collapsible assembly 32 includes a second connecting rod 321. One end of the second connecting rod 321 is rotatably connected to the intermediate part of the second upper frame body 12, and the other end of the second connecting rod 321 is pivotably connected to the second lower frame body 22.

In this example, the first upper frame body 11 and the second upper frame body 12 are connected via the first pivoting part 13, and they can be separately folded upward around the connection points thereof to the first pivoting part 13 as the rotation points. Besides, the first lower frame body 21 and the second lower frame body 22 can be separately foldable toward each other around the connection points thereof to the third lower frame body 23 as the rotation points. In addition, the first collapsible assembly 31 is disposed between the first upper frame body 11 and the first lower frame body 21, and the second collapsible assembly 32 is disposed between the second upper frame body 12 and the second lower frame body 22. When the first upper frame body 11 is folded upward around a rotation point which is the connection point to the first pivoting part 13, the first collapsible assembly 31 will drive the first lower frame body 21 to be folded upward around the rotation point which is the connection point to the third lower frame body 23. Similarly, when the second upper frame body 12 is folded upward, the second lower frame body 22 will also be driven to be folded upward, so as to reduce the storage space occupied by the carrycot. When the carrycot is to be unfolded for use, the first upper frame body 11 and the second upper frame body 12 are pulled, which will also drive the first lower frame body 21 and the second lower frame body 22 to be unfolded. Since the third lower frame body 23 is disposed between the first lower frame body 21 and the second lower frame body 22, the lower frame 2 is in a three-section configuration after being folded about first and second lower frame pivoting parts 1002 and 1004. The lower frame in the collapsed or closed position is in a U-shape where the first and second lower frame bodies are on either side of the third lower frame body. Of course, in other examples, the third lower frame body 23 itself may be in two sections or more such that the transition at the pivoting part is more fluent. The third lower frame body 23 will provide the storage space between the first lower frame body 21 and the second lower frame body 22 in the folded state. On one hand, after folding, the first lower frame body 21, the second lower frame body 22 and the third lower frame body 23 are arranged parallel in a U-shape configuration, which occupies smaller space than the frame in two-section V-shaped configuration. On the other hand, the canopy and the cloth cover soft component are unlikely to be damaged by compression and their flatness after folding is improved. Of course, in other examples, the third upper frame body may also be disposed between the first upper frame body 11 and the second upper frame body 12 to achieve better folding effect. Furthermore, the first supporting rod 312 is fixedly connected to the third lower frame body 23. As a result, in the folded state, the tilting degrees of the first upper frame body 11, the second upper frame body 12, the first lower frame body 21 and the second lower frame body 22 correspond to the tilting degree of the first supporting rod 312 such that the carrycot can be tilted toward one side to fit the stroller frame, thereby facilitating the folding of the entire stroller. The first collapsible assembly 31 is further provided with a first connecting rod 311 so that it is connected to the upper frame 1 and the lower frame 2 at discrete locations and achieve an even distribution of force, thus the structure is more stable and reliable, and is unlikely to deform. This technical solution comprises a simple structure, can be manufactured at a low cost and is not prone to malfunctions during use.

According to a preferred embodiment, the second collapsible assembly 32 further includes a third connecting rod 322. One end of the third connecting rod 322 is rotatably connected to the second upper frame body 12, and the other end of the third connecting rod 322 is rotatably connected to the connection point between the second lower frame body 22 and the third lower frame body 23.

In this example, the other end of the third connecting rod 322 is rotatably connected to the connection point between the second lower frame body 22 and the third lower frame body 23. The second collapsible assembly 32 connects to the upper frame 1 and the lower frame 2 at discrete locations to achieve an even distribution of force, thus and the structure is more stable and reliable, and is unlikely to deform.

As a preferable embodiment, the collapsible carrycot further includes an upper frame lock or locking assembly 4 which is used to lock the first pivoting part 13 such that the first upper frame body 11 and the second upper frame body 12, the first lower frame body 21 and the second lower frame body 22 cannot be folded.

In this embodiment, when the carrycot is unfolded for use, the locking assembly 4 locks the first foldable part and/or upper frame articulated joint 13, thus the first upper frame body 11 and second upper frame body 12 are unable to be folded. Since the first lower frame body 21 and the second lower frame body 22 are in linkage with the first upper frame body 11 and the second upper frame body 12 through the first collapsible assembly 31 and the second collapsible assembly 32, when the first upper frame body 11 and the second upper frame body 12 cannot be folded, the first lower frame body 21 and the second lower frame body 22 cannot be folded either. The above structure is safer and more stable as compared with the structure which maintains the use state of the carrycot using the rotation point itself. Of course, in other examples, the third lower frame body 23 may also be provided with a locking assembly 4 or a lower frame lock to lock the third lower frame body 23. Alternatively, both the first pivoting part 13 and the third lower frame body 23 are provided with the locking assemblies 4, which will also achieve the above effect.

As a preferable embodiment, the upper frame 1 is provided with an unlocking assembly 5 which can unlock the locking assembly 4.

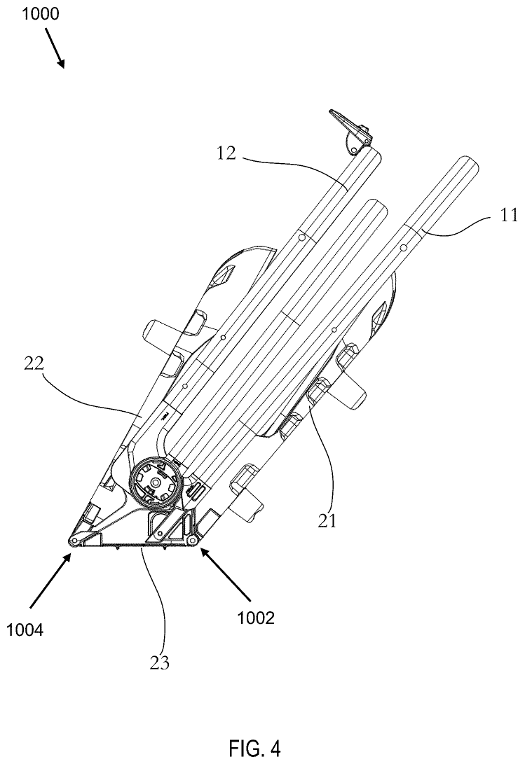

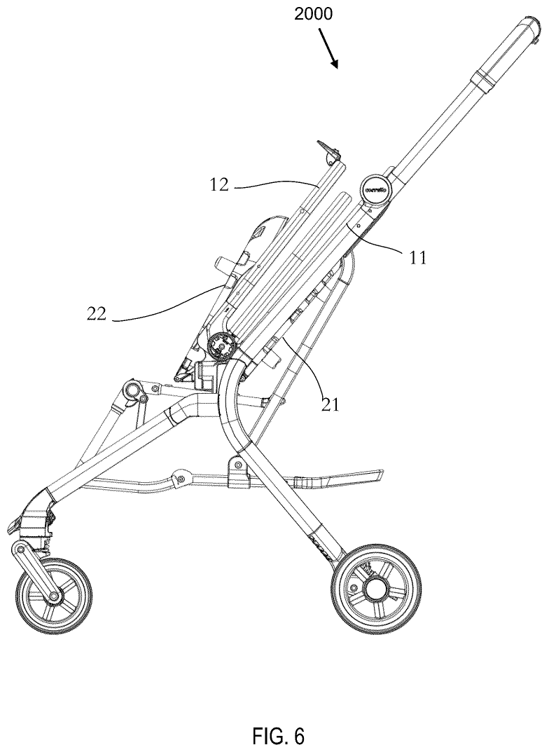

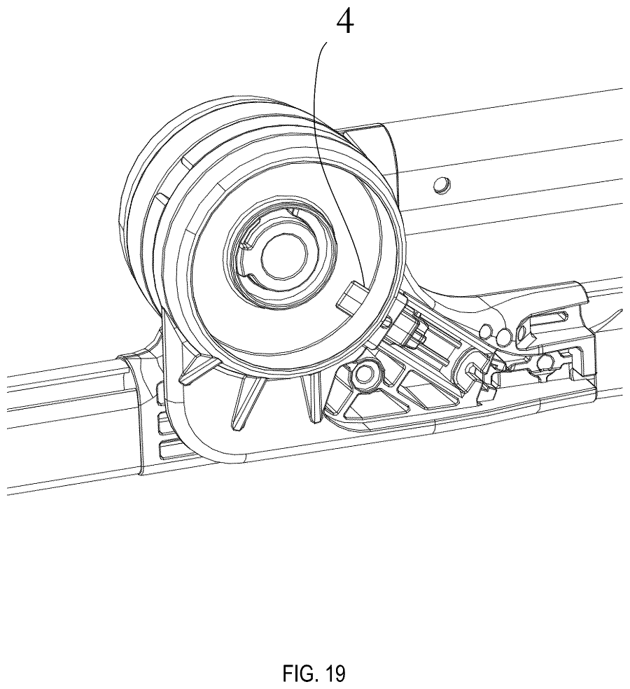

In this embodiment, the upper frame 1 is provided with the unlocking assembly 5 which unlocks the locking state of the locking assembly 4 via a pulling rope. As shown in FIG. 19, the locking assembly 4 can lock the first pivoting part 13 by using the means of a locking pin, a gear clamp, and the like. Meanwhile, as shown in FIGS. 4 and 6, when the first pivoting part 13 is in the folded; collapsed/closed state, the locking assembly 4 can also lock it to keep the entire carrycot in the folded state. The locking assembly 4 may provide or control an articulated lockable upper frame pivot assembly optionally securing the carrycot in either an open/extended state and a closed or collapsed state. Various designs of the locking assembly 4 and the unlocking assembly 5 exist, and any such equivalent mechanism may be used. The operation is more convenient and simpler as compared with the solution where the locking devices or assemblies 4 on both sides have to be manually unlocked, or even the cloth cover soft component on the carrycot needs to be removed to operate the first collapsible assembly 31 and the second collapsible assembly 32.

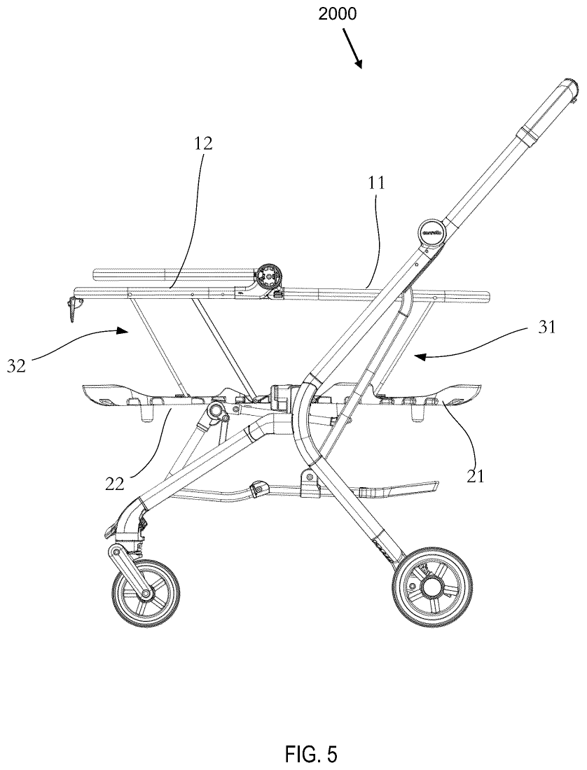

FIGS. 5 and 6 illustrate a child stroller 2000 comprising the collapsible carrycot as described above, wherein the third lower frame 23 is removably arranged on a wheeled frame of the child stroller.

In the carrycot of the child stroller of this example, the first upper frame body 11 and the second upper frame body 12 are connected via the first pivoting part 13, and they can be separately folded upward around the connection points thereof to the first pivoting part 13 as rotation points. The first lower frame body 21 and the second lower frame body 22 can also be foldable toward each other around the connection points thereof to the third lower frame body 23 as the rotation points. In addition, the first collapsible assembly 31 is disposed between the first upper frame body 11 and the first lower frame body 21, and the second collapsible assembly 32 is disposed between the second upper frame body 12 and the second lower frame body 22. When the first upper frame body 11 is folded upward around a rotation point which is the connection point to the first pivoting part 13, the first collapsible assembly 31 will drive the first lower frame body 21 to be folded upward around a rotation point which is the connection point to the third lower frame body 23. Similarly, the upward folding of the second upper frame body 12 will drive the upward folding of the second lower frame body 22, so as to reduce the storage space occupied by the carrycot. When the carrycot is to be unfolded for use, the first upper frame body 11 and the second upper frame body 12 are pulled, which will also drive the first lower frame body 21 and the second lower frame body 22 to be unfolded. Since the third lower frame body 23 is disposed between the first lower frame body 21 and the second lower frame body 22, the lower frame 2 is in a three- section-configuration after being folded. Of course, in other examples, the third lower frame body 23 itself may be in two sections or more such that the transition at the pivoting part is more fluent. The third lower frame body 23 will provide storage space between the first lower frame body 21 and the second lower frame body 22 in the folded state. On one hand, after folding, the first lower frame body 21, the second lower frame body 22 and the third lower frame body 23 are parallel arranged in a U-shape configuration, which occupies smaller space than the two-section V-shaped frame. On the other hand, the canopy and the cloth cover soft components are unlikely to be damaged by compression and their flatness after folding can be improved. Of course, in other examples, the third upper frame body may also be provided between the first upper frame body 11 and the second upper frame body 12 to achieve better folding effect. Furthermore, the first supporting rod 312 is fixedly connected to the third lower frame body 23. As a result, in the folded state, the tilting degrees of the first upper frame body 11, the second upper frame body 12, the first lower frame body 21 and the second lower frame body 22 correspond to the tilting degree of the first supporting rod 312 such that the carrycot can be tilted toward one side to fit the stroller frame, thereby facilitating the folding of the entire stroller. In addition, when the second upper frame body 12 is folded upward, a force is applied to the first pivoting part 13 to make it move downward. As the position of the rotation point of the first supporting rod 312 and the first upper frame body 11 is fixed, the second upper frame body 12 can be folded by using merely one hand, and render the carrycot to be folded as a whole. The first collapsible assembly 31 is further provided with a first connecting rod 311 so that they are connected to the upper frame 1 and the lower frame 2 at discrete locations, thus achieving an even distribution of force, and the structure is more stable and reliable, and is unlikely to deform. This technical solution has a simple structure, can be manufactured at a low cost and is not prone to malfunctions during use.

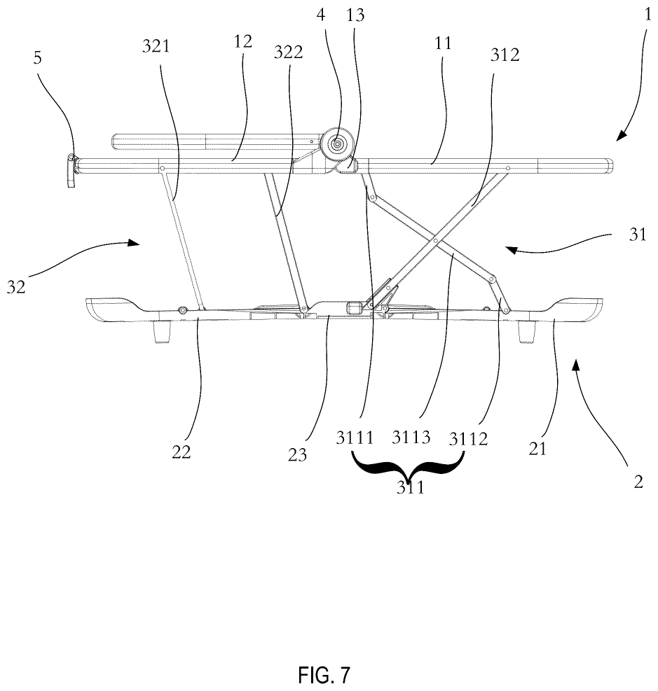

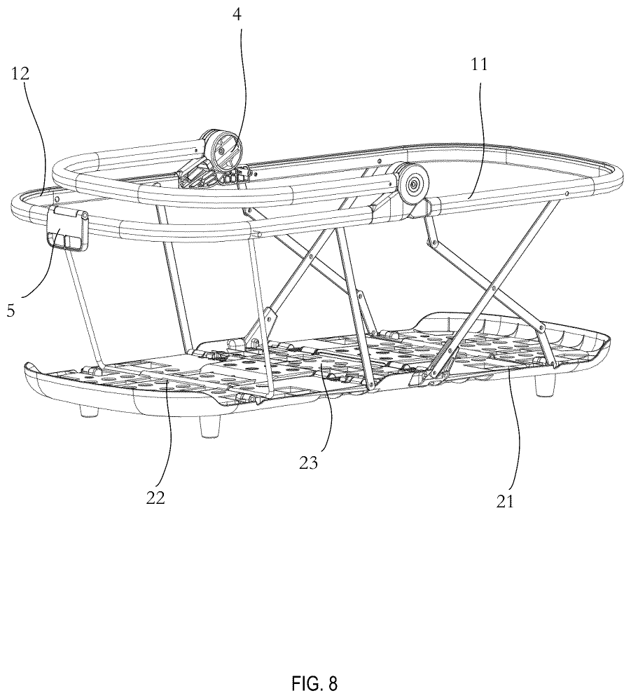

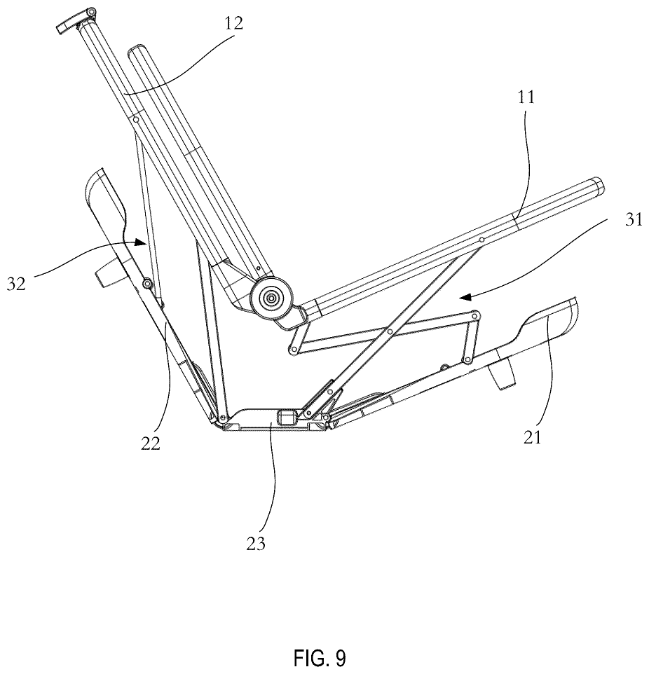

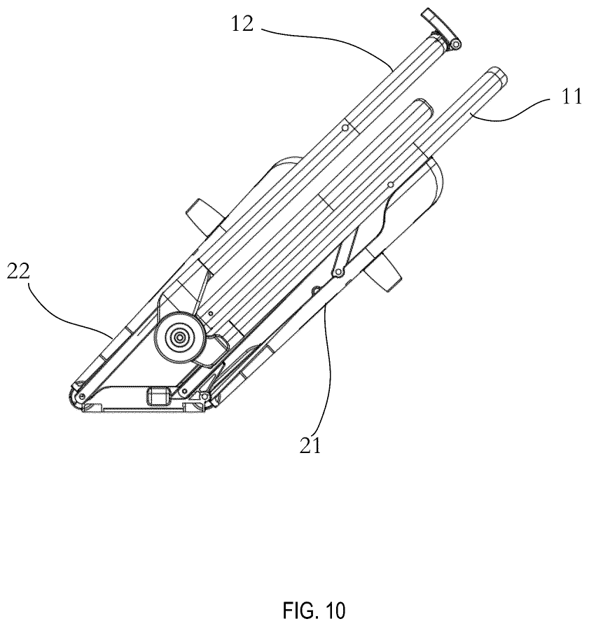

FIGS. 7 to 10 illustrate a collapsible carrycot comprising a first collapsible assembly 31 which includes a first connecting rod 311 and a first supporting rod 312. One end of the first supporting rod 312 is rotatably connected to the intermediate part of the first upper frame body 11, and the other end of the first supporting rod 312 is fixedly connected to the third lower frame body 23. As compared with Example 1, the first connecting rod 311 comprises a first sub-rod 3111, a second sub-rod 3112 and a third sub-rod 3113. The intermediate part of the third sub-rod 3113 is rotatably connected to the intermediate part of the first supporting rod 312. One end of the third sub-rod 3113 is rotatably connected to one end of the first sub-rod 3111. The other end of the third sub-rod 3113 is rotatably connected to one end of the second sub-rod 3112, and the other end of the first sub-rod 3111 is rotatably or pivotably connected to a position of the first upper frame body 11 proximal to the first pivoting part 13. The other end of the second sub-rod 3112 is rotatably connected to a position of the first lower frame body 21 distal to the third lower frame body 23. The second collapsible assembly 32 includes a second connecting rod 321. One end of the second connecting rod 321 is rotatably connected to the intermediate part of the second upper frame body 12. The other end of the second connecting rod 321 is rotatably connected to the second lower frame body 22. The sub-rods of a given connector may comprise a multi-link connector or linkage 311 as shown.

In this example, the first upper frame body 11 and the second upper frame body 12 are connected via the first pivoting part 13, and can be separately rotatably folded upward around the connection points thereof to the first pivoting part 13 as the rotation points. Besides, the first lower frame body 21 and the second lower frame body 22 can be foldable toward each other around the connection points thereof to the third lower frame body 23 as the rotation points. In addition, the first collapsible assembly 31 is disposed between the first upper frame body 11 and the first lower frame body 21, and the second collapsible assembly 32 is disposed between the second upper frame body 12 and the second lower frame body 22. The upward folding of the first upper frame body 11 will render the second lower frame body 22 to be folded upward. Meanwhile, the second upper frame body 12 drives the first sub-rod 3111 to move downward through a downward force applied by the first pivoting part 13 to the end of the first upper frame body 11 proximal to the first pivoting part 13. In addition, the intermediate part of the third sub-rod 3113 is rotatably connected to the intermediate part of the first supporting rod 312. The downward movement of the first sub-rod 3111 will drive the third sub-rod 3113 to rotate around the connection point between the third sub-rod 3113 and the first supporting rod 312. As the third sub-rod 3113 is rotatably connected to the second sub-rod 3112, the first sub-rod 3111 is rotatably connected to the first upper frame body 11, and the second sub-rod 3112 is rotatably connected to the first lower frame body 21, the rotation of the third sub-rod 3113 will pull the second sub-rod 3112 and render the upward folding of the first lower frame body 21. Furthermore, the first supporting rod 312 is fixedly connected to the third lower frame body 23. As a result, in the folded state, the tilting degrees of the first upper frame body 11, the second upper frame body 12, the first lower frame body 21 and the second lower frame body 22 correspond to the tilting degree of the first supporting rod 312 such that the carrycot can be tilted toward one side to fit the stroller frame, thereby facilitating the folding of the entire stroller.

As a preferred embodiment, the second collapsible assembly 32 further includes a third connecting rod 322. One end of the third connecting rod 322 is rotatably coupled to the second upper frame body 12, and the other end of the third connecting rod 322 is rotatably coupled to the connection point between the second lower frame body 22 and the third lower frame body 23.

In this example, the other end of the third connecting rod 322 is rotatably connected to the connection point between the second lower frame body 22 and the third lower frame body 23. The second collapsible assembly 32 connects to the upper frame 1 and the lower frame 2 at discrete locations to achieve an even distribution of force, and the structure is more stable and reliable, and is unlikely to deform.

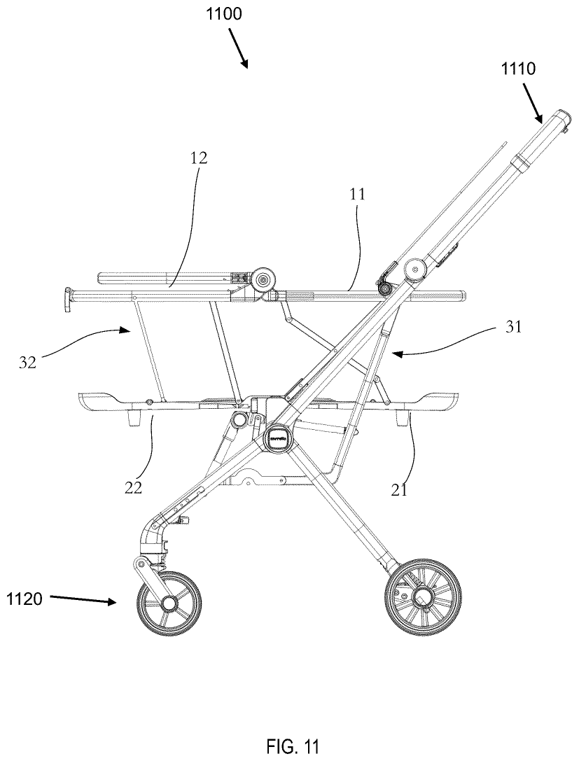

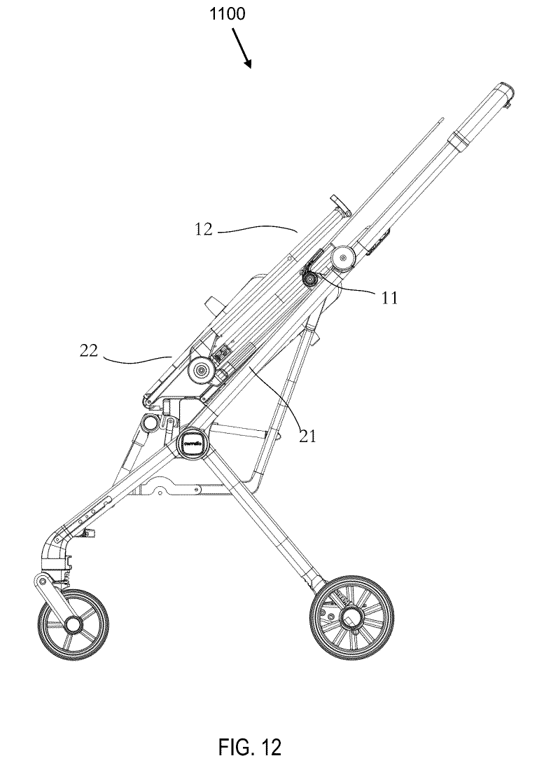

FIGS. 11 and 12 illustrate a child stroller 1100 comprising the collapsible carrycot as described above between a handle 1110 proximal to an upper portion of stroller 1100 and stroller wheels 1120 proximal to a lower portion of stroller 1100.

In the carrycot of the child stroller of this example, the first upper frame body 11 and the second upper frame body 12 are connected via the first (upper frame) pivoting part 13, and can be separately rotatably folded upward around the connection points thereof to the first pivoting part 13 as the rotation points. Besides, the first lower frame body 21 and the second lower frame body 22 can be foldable toward each other around the connections thereof to the third lower frame body 23 as rotation points. In addition, the first collapsible assembly 31 is disposed between the first upper frame body 11 and the first lower frame body 21, and the second collapsible assembly 32 is disposed between the second upper frame body 12 and the second lower frame body 22. When the first upper frame body 11 is folded upward around a rotation point which is the connection point to the first pivoting part 13, the first collapsible assembly 31 will drive the first lower frame body 21 to be folded upward around the connection point thereof to the third lower frame body 23 as the rotation point. Similarly, the upward folding of the second upper frame body 12 will drive the second lower frame body 22 to be folded upward, so as to reduce the storage space occupied by the carrycot. When the carrycot is to be unfolded for use, the first upper frame body 11 and the second upper frame body 12 are pulled, which will render the first lower frame body 21 and the second lower frame body 22 to be unfolded. Since the third lower frame body 23 is disposed between the first lower frame body 21 and the second lower frame body 22, the lower frame 2 is in a three-section-configuration after being folded. Of course, in other examples, the third lower frame body 23 itself may be in two sections or more such that the transition at the pivoting part is more fluent. The third lower frame body 23 will provide storage space between the first lower frame body 21 and the second lower frame body 22 in the folded state. On the one hand, after folding, the first lower frame body 21, the second lower frame body 22 and the third lower frame body 23 are parallel arranged in a U-shape-configuration, which occupies smaller space as compared with the two-section V-shaped frame. On the other hand, the canopy and the cloth cover soft component are unlikely to be damaged by compression and their flatness after folding can be improved. Furthermore, the first supporting rod 312 is fixedly connected to the third lower frame body 23. As a result, in the folded state, the tilting degrees of the first upper frame body 11, the second upper frame body 12, the first lower frame body 21 and the second lower frame body 22 correspond to the tilting degree of the first supporting rod 312 such that the carrycot can be tilted toward one side to fit the stroller frame, thereby facilitating the folding of the entire stroller. In addition, when the second upper frame body 12 is folded upward, a force is applied to the first pivoting part 13 to make it move downward. As the position of the rotation point of the first supporting rod 312 and the first upper frame body 11 is fixed, the second upper frame body 12 can be folded with only one hand and rendering the carrycot to be folded as a whole.

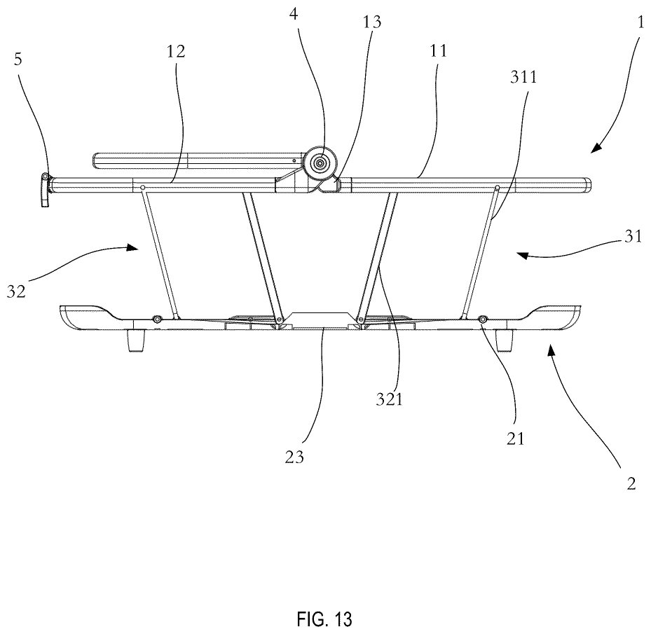

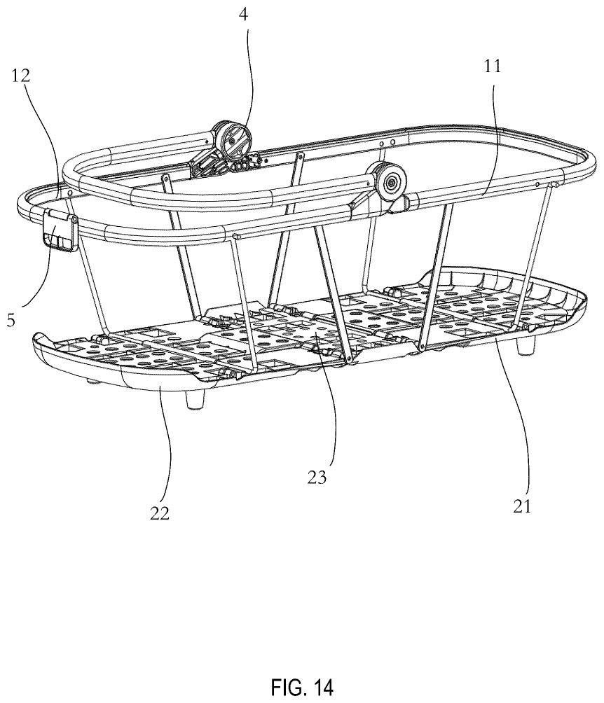

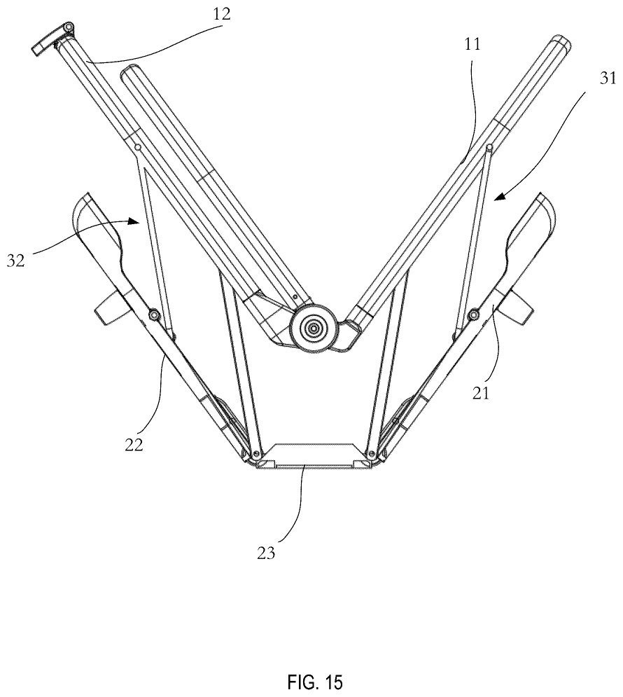

FIGS. 13 to 15 illustrate a collapsible carrycot comprising a first collapsible assembly 31 which includes a first connecting rod 311. One end of the first connecting rod 311 is rotatably connected to the intermediate part of the first upper frame body 11, and the other end of the first connecting rod 311 is rotatably connected to the first lower frame body 21.

In this embodiment, one end of the first connecting rod 311 is connected to the intermediate part of the first frame body 11. The upper frame 1 and the lower frame 2 have uniform force bearing points, and thus are unlikely to deform. The first collapsible assembly 31 is in linkage with the folding motion of the first upper frame body 11 and the first lower frame body 21 via the first connecting rod 311 disposed between the first upper frame body 11 and the first lower frame body 21, leading to a simple structure and low manufacturing cost.

As a preferred embodiment, the first collapsible assembly 31 further includes a second connecting rod 321. One end of the second connecting rod 321 is rotatably connected to the first upper frame body 11, and the other end of the second connecting rod 321 is rotatably connected to the connection point between the first lower frame body 21 and the third lower frame body 23.

In this embodiment, the other end of the second connecting rod 321 is rotatably connected to the connection point between the first lower frame body 21 and the third lower frame body 23. The first collapsible assembly 31 connects to the upper frame 1 and the lower frame 2 at discrete locations to achieve an even distribution of force, and the structure is more stable and reliable, and is unlikely to deform.

As a preferable embodiment, the second collapsible assembly 32 and the first collapsible assembly 31 are symmetrically arranged.

In this embodiment, the second collapsible assembly 32 and the first collapsible assembly 31 are symmetrically arranged, thus the carrycot has a simple structure and low manufacturing cost.

This example further provides a child stroller comprising any one of the above collapsible carrycots.

In the carrycot of the child stroller of this example, the first upper frame body 11 and the second upper frame body 12 are connected via the first pivoting part 13, and can be separately folded upward around the connection points thereof to the first pivoting part 13 as the rotation points. Besides, the first lower frame body 21 and the second lower frame body 22 can also be foldable toward each other around the connection points thereof to the third lower frame body 23 as the rotation points. In addition, the first collapsible assembly 31 is disposed between the first upper frame body 11 and the first lower frame body 21, and the second collapsible assembly 32 is disposed between the second upper frame body 12 and the second lower frame body 22. When the first upper frame body 11 is folded upward around a rotation point which is the connection point to the first pivoting part 13, the first collapsible assembly 31 will drive the first lower frame body 21 to be folded upward around a rotation point which is the connection point to the third lower frame body 23. Similarly, when the second upper frame body 12 is folded upward, the second lower frame body 22 will also be driven to fold upward, so as to reduce the storage space occupied by the carrycot. When the carrycot is to be unfolded for use, the first upper frame body 11 and the second upper frame body 12 are pulled, which will also drive the first lower frame body 21 and the second lower frame body 22 to be unfolded. Since the third lower frame body 23 is disposed between the first lower frame body 21 and the second lower frame body 22, the lower frame 2 is in a three- section-configuration after being folded. Of course, in other examples, the third lower frame body 23 itself may be in two sections or more such that the transition at the pivoting part is more fluent. The third lower frame body 23 will provide storage space between the first lower frame body 21 and the second lower frame body 22 in the folded state. On one hand, after folding, the first lower frame body 21, the second lower frame body 22 and the third lower frame body 23 are arranged in a U-shape configuration, which occupies smaller space than the two-section V-shaped frame. On the other hand, the canopy and the cloth cover soft component are unlikely to be damaged by compression and their flatness after folding can be improved.

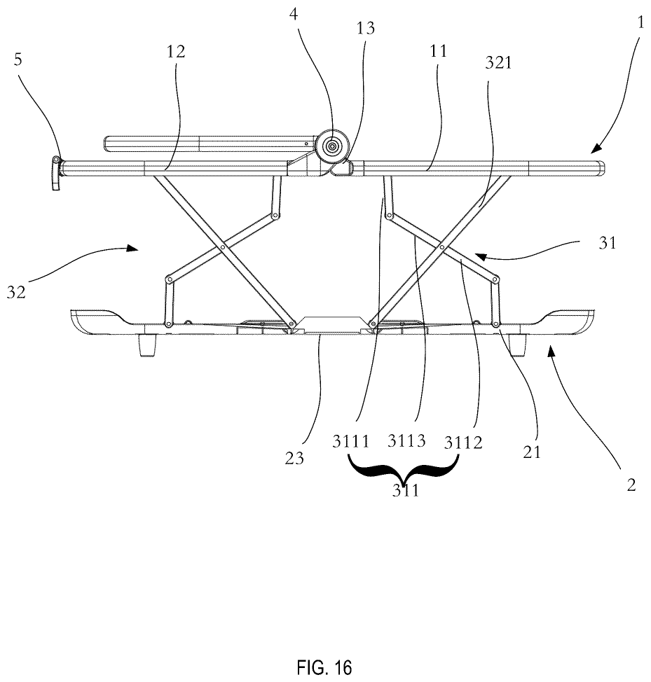

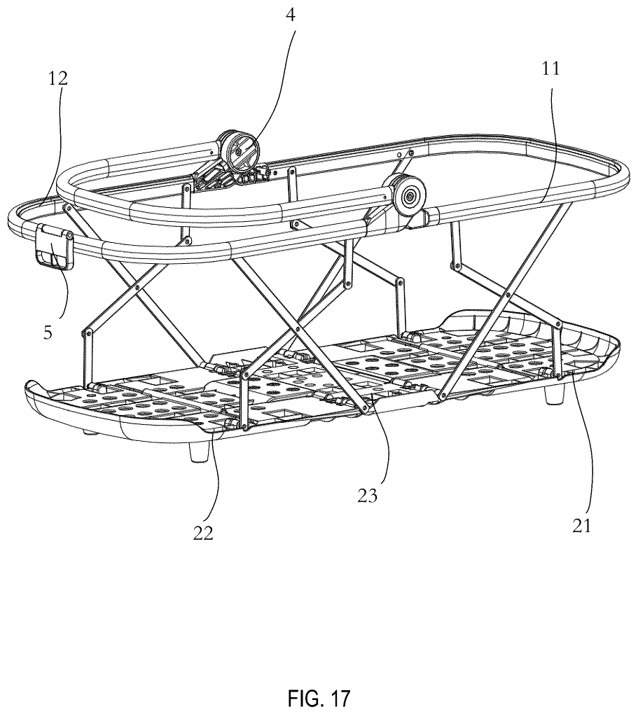

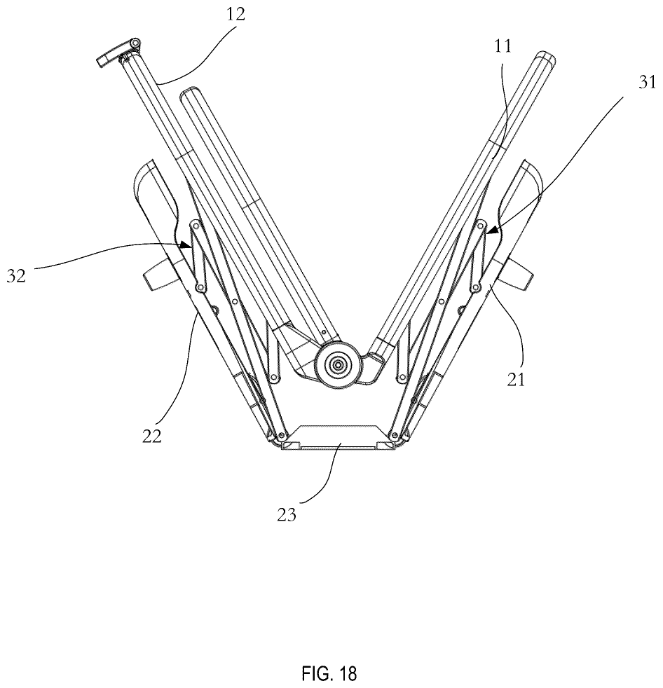

FIGS. 16 to 18 illustrate a collapsible carrycot comprising a first collapsible assembly 31 which includes a first connecting rod 311 and a second supporting rod 321. One end of the second connecting rod 321 is rotatably connected to the intermediate part of the first upper frame body 11. The other end of the second connecting rod 321 is rotatably connected to the connection point between the first lower frame body 21 and the third lower frame body 23. The first connecting rod 311 comprises a first sub-rod 3111, a second sub-rod 3112, and a third sub-rod 3113, which form an articulated multi-link connecting member. The intermediate part of the third sub-rod 3113 is rotatably connected to the intermediate part of the second support rod 321. One end of the third sub-rod 3113 is rotatably connected to one end of the first sub-rod 3111. The other end of the third sub-rod 3113 is rotatably connected to one end of the second sub-rod 3112. The other end of the first sub-rod 3111 is rotatably connected to a position of the first upper frame body 11 proximal to the first pivoting part 13. The other end of the second sub-rod 3112 is rotatably connected to a position of the first lower frame body 21 distal to the third lower frame body 23.

In this embodiment, both ends of the second connecting rod 321 are rotatably connected to the intermediate part of the first upper frame body 11 and the connection point between the first lower frame body 21 and the third lower frame body 23, respectively. When the first upper frame body 11 is being folded upward, the second connecting rod 321 is driven to rotate around a rotation point which is the connection point between the first lower frame body 21 and the third lower frame body 23. In addition, the intermediate part of the third sub-rod 3113 is rotatably connected to the intermediate part of the second connecting rod 321. Rotation of the second connecting rod 321 drives the third sub-rod 3113 to rotate around the connection point between the third sub-rod 3113 and the second connecting rod 321. As the third sub-rod 3113 is rotatably connected to the first sub-rod 3111 and the second sub-rod 3112, the first sub-rod 3111 is rotatably connected to the first upper frame body 11, and the second sub-rod 3112 is rotatably connected to the first lower frame body 21, the rotation of the third sub-rod 3113 will pull the second sub-rod 3112 and drive the first lower frame body 21 to be folded upward. In the above structure, the first collapsible assembly is in a cross X shape and the force-bearing positions of the connection points with the first upper frame body 11 and the first lower frame body 21 are dispersed uniformly. Therefore, the structure is more stable and reliable.

As a preferable embodiment, the second collapsible assembly 32 and the first collapsible assembly 31 are symmetrically arranged.

The second collapsible assembly 32 and the first collapsible assembly 31 are symmetrically arranged. The carrycot has a simple structure and low manufacturing cost. Of course, in other examples, the second collapsible assembly 32 may be configured to form an asymmetric configuration.

This example further provides a child stroller comprising the collapsible carrycot as described above.

Although the above describes specific embodiments of the present application, it is understood by those skilled in the art that the embodiments are merely for illustrative purposes, and the protection scope of the present application is defined by the claims that follow. Various modifications and variations can be made to the embodiments by those skilled in the art without departing from the principle and essence of the present application, although the modifications and variations fall within the protection scope of the present application.

What is claimed is:

1. A collapsible carrycot comprising:
an upper frame having a first upper frame body and a second upper frame body, the first and second upper frame bodies being rotatably coupled to one another by an upper frame pivoting part, so that the first and second upper frame bodies are foldable with respect to one another about said upper frame pivoting part;
a lower frame having a first lower frame body, a second lower frame body, and a third lower frame body, the first and third lower frame bodies being rotatably coupled to one another, and the second and third lower frame bodies being rotatably coupled to one another, so that the first and second lower frame bodies are foldable with respect to one another about said third lower frame body;
a first collapsible assembly collapsibly coupling said first upper frame body and said first lower frame body;
a second collapsible assembly collapsibly coupling said second upper frame body and said second lower frame body;
wherein the carrycot is convertible between an extended position with said upper frame pivoting part in a first position thereof, and a collapsed position with said upper frame pivoting part in a second position thereof.

2. The collapsible carrycot of claim 1, further comprising a locking device and an unlocking device, wherein the carrycot can be locked in any of the extended position and the collapsed position using said locking device, and the unlocking device permits unlocking of the locking device to transition the carrycot between said extended and said collapsed positions.

3. The collapsible carrycot of claim 2, further comprising a cable extending from said unlocking device to said locking device, configured and arranged to cause a release of said locking device when said cable is actuated at said unlocking device.

4. The collapsible carrycot of claim 1, wherein the first collapsible assembly comprises a first connecting rod coupled to each of said first upper frame body and said first lower frame body, and a first supporting rod coupled to each of said first upper frame body and said third lower frame body.

5. The collapsible carrycot of claim 4, wherein the first connecting rod is rotatably coupled at one end thereof to said first upper frame body and rotatably coupled at another end thereof to said first lower frame body.

6. The collapsible carrycot of claim 4, wherein the first supporting rod is rotatably coupled at one end thereof to said first upper frame body and fixed at another end thereof to said third lower frame body.

7. The collapsible carrycot of claim 1, wherein the second collapsible assembly comprises a second connecting rod coupled to each of said second upper frame body and said second lower frame body, and a third connecting rod coupled to each of said second upper frame body and said third lower frame body.

8. The collapsible carrycot of claim 7, wherein the second connecting rod is rotatably coupled at one end thereof to said second upper frame body and rotatably coupled at another end thereof to said second lower frame body.

9. The collapsible carrycot of claim 7, wherein the third connecting rod is rotatably coupled at one end thereof to said second upper frame body and rotatably coupled at another end thereof to said third lower frame body.

10. The collapsible carrycot of claim 1, further comprising at least one lower frame pivoting part coupling said third lower frame body with at least one of said first lower frame body and said second lower frame body.

11. The collapsible carrycot of claim 1, configured and arranged to mechanically lock into a mobile stroller for transporting said carrycot.

12. The collapsible carrycot of claim 1, wherein any of said collapsible assemblies comprises at least one articulated multi-link connecting member.

13. The collapsible carrycot of claim 1, further comprising a lower frame lock that locks said lower frame bodies in place when the carrycot is in said extended position or in said collapsed position.

14. The collapsible carrycot of claim 1, wherein the lower frame is in a U-shape when in said collapsed position, defined by said first and second lower frame bodies on either side of said third lower frame body.

15. A stroller, comprising a wheeled stroller frame, a handle, and the collapsible carrycot of claim 1.

16. A collapsible stroller and carrycot apparatus, comprising:
a stroller frame having a plurality of stroller frame coupling points configured to mechanically couple to a corresponding plurality of carrycot coupling points;
a stroller handle proximal to an upper portion of said stroller frame;
a plurality of stroller wheels proximal to a lower portion of said stroller frame; and
a collapsible carrycot comprising:
an upper carrycot frame and a lower carrycot frame;
wherein said upper carrycot frame includes a first upper frame body, a second upper frame body, said first and second upper frame bodies being rotatably foldable with respect to one another by way of a lockable upper frame pivoting part;
wherein said lower carrycot frame includes a first lower frame body, a second lower frame body, and a third lower frame body, said first and third lower frame bodies being rotatably foldable with respect to one another by way of a first lower frame pivoting part, and said second and third lower frame bodies being rotatably foldable with respect to one another by way of a second lower frame pivoting part;
wherein said collapsible carrycot is foldably convertible between an extended position and a collapsed position;
wherein in the extended position of the carrycot: each of said first and second upper frame bodies is open about said upper frame pivoting part and secured in said extended position by a locking device, and wherein each of said first, second and third lower frame bodies is open about said respective first and second lower frame pivoting parts; and
wherein in the collapsed position of the carrycot: each of said first and second upper frame bodies is closed about said upper frame pivoting part and secured in said collapsed position by said locking device, and wherein each of said first, second and third lower frame bodies is closed about said respective first and second lower frame pivoting parts.

17. A collapsible stroller and carrycot apparatus of claim 16, wherein the lower carrycot frame is in a U-shape when in said collapsed position, defined by said first and second lower frame bodies on either side of said third lower frame body.
